(19) United States
(12) Patent Application Publication
(10) Pub. No.: US 2021/0096378 A1
(43) Pub. Date: Apr. 1, 2021

(54) NEAR-EYE DISPLAY WITH A FLAT PIXEL ARRAY

(71) Applicant: Optotune AG, Dietikon (CH)

(72) Inventor: Manuel ASCHWANDEN, Allenwinden (CH)

(73) Assignee: Optotune AG, Dietikon (CH)

(21) Appl. No.: 17/036,433

(22) Filed: Sep. 29, 2020

(30) Foreign Application Priority Data
Sep. 30, 2019 (EP) 19200637
Sep. 30, 2019 (IB) PCT/IB2019/058315

(51) Int. Cl. G02B 27/01; G02B 27/30

(52) U.S. Cl. CPC G02B 27/0172; G02B 27/30; G02B 2027/0138; G02B 2027/0198; G02B 2027/0178

(57) ABSTRACT

The invention relates to a near-eye display (1) comprising at least one pixel array (2), wherein the at least one pixel array (2) is planar and comprises a plurality of pixels (3) arranged in a plane, wherein each pixel (3) comprises a central emitter (60) configured to emit light in a controllable fashion, wherein the at least one pixel array (2) comprises an optical assembly (70) configured and adapted to collimate emitted light from each central emitter (60) of the pixel array (2) and to deflect the collimated light (101) from each pixel (3) such that the light emitted (100) from the central emitter (60) of each pixel (3) of the pixel array (2) propagates toward a common center portion (80) of the near-eye display (1).

Furthermore, the invention relates to glasses (40) comprising a near-eye display (1) according to the invention.

### CROSS-REFERENCE TO RELATED APPLICATIONS

Benefit is claimed to International Patent Application No. PCT/IB2019/058315, filed Sep. 30, 2019, and European Patent Application No. 19200637, filed Sep. 30, 2019; the contents of both of which are incorporated by reference herein in their entirety.

### FIELD

The invention relates to a near-eye display according to claim 1 as well as to glasses comprising such a near-eye display.

### BACKGROUND

Near-eye displays are configured to be arranged at distances to the eye of a user that are below or almost below the focusing abilities of the human eye. An object located at these distances cannot be brought into focus by the human eye, i.e. the eye is not capable to focus without strain or not at all on the object. The object appears out-of-focus.

Near-eye displays therefore face the challenge to be able to display discernable, sharp images to a user despite being arranged “too” close to the eye.

This problem has been solved by placing a lens or other optical means in front of a conventional display, such that the eye can bring the image into focus.

Alternatively, light field displays have been proposed in order to solve this problem. Light field displays are configured to generate wavefronts of light that simulate wavefronts of objects that are spaced further away.

With light field displays, there is no need for the eye to (impossibly) focus on the display pixels. The pixels of a light field display comprise microlenses that are assembled in a microlens array. Starting from the viewer's eye, behind each microlens is a small pixel-based display, for example comprising one or more light-emitting diodes (LED), for example OLED, is located that emits or forms a partial image of the scene to be represented to the viewer, wherein each partial image corresponds to a view of the object to be displayed, for example from the viewer's perspective, at one or more azimuthal angles and one or more elevation angles, for example over one or more azimuthal sectors and one or more elevation sectors.

Light field displays therefore suffer the problem that each pixel consists of a small display itself, which in turn limits the size and resolution of the microlens pixels.

Furthermore, light field displays render, for example, a plurality of different sub-images for the small displays of the microlenses which results in heavy computational costs.

For example, an advantageous implementation of a near-eye display comprises a plurality of pixels that are arranged, for example, on a curved screen, wherein each pixel comprises an emitter, for example aligned with the microlens' optical axis, for example called a central emitter, that is configured to emit light, for example light, one or more of the intensity and color of which are controlled by a processor executing computer-readable instructions stored in a non-volatile computer storage device. For example, each pixel further comprises a collimating optics, for example comprising a microlens, that is configured to collimate the emitted light of each pixel.

For example, the light, for example collimated light, exits the microlens such that it propagates parallel to the optical axis of the pixel. The optical axis of the pixel is, for example, defined by the curve of the screen (or display) as the optical axis of the pixel is orthogonal to the surface of the screen. In some embodiments, the surface of the screen is, for example, curved around one or more axes, for example one or more of: the axis of azimuthal angles; and the axis of elevation angles.

For example, the near-eye display comprises one or more pluralities of pixels, for example all pixels, wherein the optical axes of the pixels intersect at one point of convergence. For example, the point of convergence is comprised in the eye, for example the pupil, for example the optical center of the eye, a person wearing the near-eye display, for example when the person is gazing straight ahead in azimuth and elevation angles.

For some embodiments, the cost of manufacturing a curved screen is greater than that of manufacturing a flat screen. In some embodiments, the optical axes of the pixels do not intersect at one point of convergence.

### SUMMARY

An embodiment of the present invention provides a near-eye display, for example a wearable near-eye display, for example a near-eye display that comprises glasses or, conversely, glasses that comprise one or more near-eye displays.

According to claim 1, the near-eye display comprises at least one pixel array, wherein the at least one pixel array is, for example, planar. For example, the pixel array comprises a plurality of pixels arranged in a plane, wherein each pixel comprises a central emitter configured to emit light. For example, one or more central emitters comprise one or more of: light emitting diodes (LED); and organic light emitting diodes (OLED). For example, one or more of the intensity and color of the light produced by each of the one or more emitters is controlled by a processor executing computer-readable instructions stored on a non-volatile computer storage device. For example, the at least one pixel array comprises an optical assembly configured and adapted to collimate emitted light from each central emitter of the pixel array and to deflect the collimated light from each pixel such that the light emitted from the central emitter of each pixel of the pixel array propagates towards a point of convergence, for example called a common center portion of the near-eye display.

The foregoing and other objects, features, and advantages will become more apparent from the following detailed description, which proceeds with reference to the accompanying figures.

### BRIEF DESCRIPTION OF THE DRAWINGS

FIG. 1 shows a schematic cross-section through a near-eye display.

FIG. 2 schematically shows an embodiment of the invention that comprises three planar pixel arrays 2, 2′, 2″ that are arranged around and oriented towards the common center portion of the near-eye display. In panel A, the near-eye display is arranged further away from the eye of the user than in panel B.

FIG. 3 is a more detailed view of the schematic embodiment shown in FIG. 2, and similarly shows an embodiment of the invention that comprises three planar pixel arrays 2, 2′, 2″ that are arranged around and oriented towards the common center portion of the near-eye display. In panel A, the near-eye display is arranged further away from the eye of the user than in panel B.

FIG. 4 shows an embodiment of the near-eye display, where the near-eye display is comprised and embedded in a transparent substrate such as a polymer. In panel A of FIG. 4 the schematic cross-section of the near-eye display is shown and in panel B a frontal view of the near-eye display is shown.

FIG. 5 shows a schematic illustration of glasses according to the invention.

FIG. 6 shows an exemplary embodiment of the near-eye display that can be part of glasses as described previously, wherein the near-eye display comprises a plurality of pixel arrays that are all oriented in the same direction, namely towards a common z-axis.

FIG. 7 shows an alternative layout for a near-eye display with a plurality of pixel arrays schematically shown in cross-sections. In panel A an embodiment is shown, where each pixel array is essentially are planar. An alternative embodiment is shown in FIG. 7 panel B, where the pixel arrays are arranged on a planar window or substrate, but with orientations (depicted as dotted lines) that correspond to an arrangement on a curved substrate.

FIG. 8 shows the side of the pixel to which light is emitted is indicated by the arrow. In FIG. 8 panel A, a single pixel of the pixel array is schematically shown in a cross-section. In FIG. 8 panel B, a single pixel of the pixel array is schematically shown in a cross-section.

### DETAILED DESCRIPTION

In one example, the near-eye display is configured to be arranged at a distance shorter than 70 mm with respect to the eye, for example a distance to the surface of the eye, for example at the pupil of the eye. For example, the near-eye display is positioned at a distance from the eye wherein an image displayed by the near-eye display appears in focus, for example over one or more azimuthal sectors and elevation sectors. For example, the user perceives the image as being in focus despite the near-eye display being arranged so closely to the eye. For example, the surface of the near-eye display that is closest to the surface of the pupil, the so-called vertex distance, is comprised in a range from 5 mm to 70 mm, for example from 5 mm to 30 mm, for example from 5 mm to 20 mm, for example from 10 mm to 15 mm, for example from 12 mm to 14 mm.

Compared to embodiments for a near-eye display comprising a curved screen, a near-eye display embodiment comprising one or more flat screens has, for example, a lower cost and a greater range of screen arrangements, for example azimuthal and elevation settings with respect to a wearer's straight ahead axis.

The term “pixel array” refers, for example, to a plurality of pixels, for example light-emitting pixels, that are arranged in a common plane. For example, a pixel array is a screen comprising a plurality of pixels that are arranged in a repeating grid of rows and columns of pixels, for example a grid of orthogonal rows and columns. In another example, a pixel array is a screen comprising a plurality of pixels arranged in a hexagonal packing arrangement.

We define, for example, an x, y, z Cartesian coordinate system wherein x, y is in the plane of the at least one pixel array. The z-axis extends, for example, along a surface normal to the at least one pixel array and away from the viewer.

For example, the at least one planar pixel array is arranged in a plane extending orthogonally to the optical axis of the eye of a user gazing straight ahead in azimuth and elevation. For example, the center of the at least one pixel array is aligned with the optical axis of the user's eye gazing straight ahead. For example, a field of view of the near-eye display extends, in one or more of azimuth and elevation, to cover the field of view of the user. For example, the field of view for an eye of the near-eye display covers a display sector of about 150° in or more of azimuth and elevation. The display sector is, for example, comprised in a range from 90° to 160°. The near-eye display comprises, for example, a display sector for each eye of the user.

The pixel array is, for example, square or rectangular along the plane of extent.

The term “pixel” in the context of the specification relates, for example, to a light emitting device. A light emitting device comprises, for example, at least one light emitting entity—the central emitter. A light emitting device comprises, for example, one or more of an LED, an OLED, an active matrix LED (AMOLED), and quantum dots.

For example, the pixels of a pixel array have a dimension, for example along one or more of the x, and y axes, that is comprised in a range from about 1 μm to 100 μm, for example from about 2 μm to 40 μm, for example from about 2 μm to 20 μm. In some embodiments, for example, a pixel subtends an angle that is smaller than 28 arc second with respect to the user's eye.

For example, the pixel array is planar.

The term “planar pixel array” refers, for example, to a planar embodiment within which all the central emitters of the pixel array are arranged. A planar pixel array comprises, for example, central emitters, for example all central emitters, that are arranged in a same plane, for example within manufacturing tolerances.

For example, a surface of the pixel array, for example a surface that faces the user's eye, comprises one or more curves. For example, the surface of the pixel array is non-planar. For example, the pixel array comprises one or more parts, for example one or more lenses, of the optical assembly.

The central emitter comprises, for example, a controllable emission portion, for example a spatial portion in the plane of the pixel array, of the pixel. For example, the central emitter comprises one or more of: a physical emitter element; and a scattering element. For example, the central emitter is illuminated by a separate source, for example a source comprised in a component that is external to the plane of the pixel array. For example, the central emitter emits light in point-emitter-like fashion, for example a point light source. For example, in some embodiments the emitted light of the central emitter is emitted with a wavefront curvature comprised in a range from one-tenth of the inter-pixel distance to 100 times the inter-pixel distance.

For example, the central emitter adopts at least two optically distinct, for example visually distinguishable, states—for example a luminous state (on-state) and a non-luminous state (off-state). For example, the central emitter changes one or more of: color, scattering properties, intensity, and polarization upon one or more of activation (on-state) and deactivation (off-state). A central emitter is, for example, connected to a computer processor, for example executing instructions stored on a non-volatile computer storage device, for example instructions to adjust one or more of: color, scattering properties, intensity, polarization, activation, and deactivation.

A point source is, for example, a source that comprises a fixed spatial distribution of it emission characteristics. For example, a source does not comprise the capabilities to display spatially varying emission properties, unlike a plurality of pixels.

Furthermore, the central emitter is, for example, smaller than 25 μm, more particularly smaller than 10 μm, 5 μm or 1 μm.

The terms “in a controllable fashion” or “controllable” particularly indicates that the central emitter can be addressed and controlled individually. This allows controlling the state of each central emitter independent of the other central emitters of the near-eye display. For example, one or more central emitters are individually controlled by a computer processor, for example executing instructions stored on a non-volatile computer storage device to individually control the central emitters.

The light emitted by one or more central emitters is, for example, within the visible spectral region.

According to some embodiments the computer processor executes instructions, for example instructions stored on the non-volatile computer storage device, to command one or more central emitters to emit light in one or more wavelength bands. For example, a central emitter provides light comprising a plurality of wavelengths, for example one or more of a red wavelength, a green wavelength, a blue wavelength, an infrared wavelength, and an ultraviolet wavelength.

For example, the light emitted by the central emitter is divergent and is collimated by the corresponding collimating optics. Upon exiting the collimating optics, the collimated light propagates towards the eye of the user, where a sharp image on the retina of the eye is formed.

For example, the light from each central emitter reaches the eye as collimated light. For example, the optical assembly is configured, arranged, and adapted to collimate emitted light from each central emitter of the at least one pixel array.

For example, the optical assembly is configured to collimate the divergent light emitted by the central emitters.

For example, the parallelism of the collimation includes an error margin, for example an error that causes a blurring of the illumination spot caused by a central emitter on the retina of the user. For example, the error margin for a central emitter forming an illumination spot on the fovea of the user is comprised in a range from about 2 arc second to about 100 arc second, for example from about 10 arc to about 30 arc second. As the near-eye display is arrangeable comparably close to the eye and the beam diameter of emitted light of an optical element is comparably small, collimation does not need to be perfect.

For example, light from the central emitter comprises a collimation error, for example due to manufacturing tolerances. Furthermore, other factors can influence the collimation properties and quality, such as, for example, optical aberrations and non-perfect collimating geometries of the optical assembly.

Moreover, the optical assembly is configured, arranged, and adapted to deflect the collimated light from each pixel such that the light of each pixel of the pixel array propagates toward a common center portion of the near-eye display.

For example, the optical assembly comprises one or more optical components, for example one or more of lenses, prisms, and mirrors, that are one or more of formed and oriented to form one or more of the collimation and the deflection towards the common center portion. For example, the one or more optical components, for example the one or more of lenses, prisms, and mirrors, comprise one or more actuators to adjust one or more of the three-dimensional coordinates, the azimuth, and the elevation of the optical axes of the one or more optical components to converge emitted light towards the common center portion. For example, the one or more actuators is controlled by a processor executing computer-readable instructions stored on a non-volatile computer storage device.

The optical assembly is particularly arranged on top of each pixel on a side of the near-eye display that faces the eye of the user. For example, the optical assembly is comprised between the pixel array and the eye of the user.

The common center portion of the near-eye display is, for example, at a location where the center of the eye ball, for example the pupil, of a user is located. For example, the common center portion comprises an aperture in a range from 2 mm to 8 mm, for example 4 mm. In some embodiments, the common center portion is at the optical center of the eye of the user, for example wherein the user is gazing straight ahead. For example, the collimated light from each central emitter converge to a location of the common center portion defined with an error margin in a range from 0.5 mm to 8 mm, for example from 1 mm to 4 mm. For example, the common center portion, for example its three-dimensional extent, for example defined as an ellipsoid, is defined as a function of one or more gazing positions of a user's eye, for example a standard user's eye, for example the positions of the optical center of a user's eye.

The common center portion is therefore particularly arranged outside of the plane comprising the pixel array.

According to another embodiment of the invention, each pixel comprises a reflective portion on which the central emitter is arranged.

According to another embodiment of the invention, the central emitter is coated with a conductive polymer shell, and is arranged on the reflective portion, wherein the shell provides a fixed distance between a core of the central emitter and the reflective portion, such that the coated central emitter forms an electrochromic nanoparticle-on-mirror (eNPoM) with the reflective portion, such that an emission wavelength of the central emitter is adjustable by adjusting a plasmonic resonance of the eNPOM.

The reflective portion is for example made of a metallic compound, such as gold. The central emitter in the eNPoM is for example made of gold, particularly the core of the central emitter is made of a metal such as gold.

According to another embodiment of the invention, the central emitter is coated with a thin film of a conductive polymer shell, such as polyaniline.

The thin film might have thickness between 1 nm to 50 nm, particularly between 10 nm to 30 nm, more particularly 20 nm.

The core of the central emitter might have diameter in the range of 20 nm to 200 nm, particularly in the range of 50 nm to 150 nm, more particularly in the range of 70 to 90 nm.

Such nanoparticle-on-mirror devices are for example known from DOI: 10.1126/sciadv.aaw2205. the context of which is herewith incorporated in the application. According to another embodiment, the optical assembly comprises a collimating optics comprised by each pixel, particularly wherein the collimating optics comprises one or more of: i) a micro-lens array; and ii) a micro-mirror array. For example, the collimating optics of each pixel is arranged such that light emitted from the central emitter is collimated by the collimating optics.

For example, the collimating optics comprises a plurality of collimating elements, for example one or more of lenses and mirrors, wherein each collimating element is associated to and arranged at a pixel and collimates the light of the corresponding pixel.

The terms “micro-lens array” and “micro-mirror array” particularly refer to a component that comprises a plurality of lenses or mirrors, respectively, wherein said lenses or mirrors are arranged exactly or approximately in the same pattern, for example a superimposable pattern, as the central emitters, particularly such that each lens or mirror is associated to one central emitter and collimates light emitted by said central emitter.

For example, in case the collimating optics comprises collimating lenses, for example as an embodiment of a micro-lens array, the collimating optics is arranged between the central emitters and the desired location for the eye of the user. For example, the desired location for the eye of the user is defined by a frame forming an interface between the near-eye display and the user's head, for example glasses frame, for example goggles.

In case the collimating optics comprises collimating mirrors or is a micro-mirror array, the central emitters are arranged between the collimating optics and the eye of the user.

According to another embodiment, the collimating optics of adjacent pixels are arranged such with respect to the central emitters of the adjacent pixels that the collimated light of the adjacent pixels is emitted at different angles, such that the emitted light of the at least one pixel array propagates toward the common center portion of the near-eye display, particularly wherein the optical assembly is formed by the collimating optics only.

According to this embodiment the collimating optics of adjacent pixels is laterally shifted, for example along one or more of the azimuthal plane and the elevation plane, with respect to the corresponding the central emitters. For example, in case the optical axis of the collimating optics of a pixel is in alignment with the central emitter, collimated light propagates parallel to or on the optical axis of the collimating optics. For example, in case the optical axis of the collimating optics of a pixel is laterally shifted with respect to the corresponding central emitter, the collimated light propagates at a well-defined pre-determined angle with respect to the optical axis of the collimating optics.

Said angle is, for example, calculated using the focal length of the collimating optics and the relative displacement of the central emitter with respect to the optical axis of the corresponding collimating optics.

According to this embodiment, the collimating optics is, for example, the optical assembly. For example, the optical assembly consists of the collimating optics arranged in the specific way laid out in this embodiment.

Therefore, a near-eye display is provided comprising a planar screen that is configured to project light with the appropriate angles that converge to the user's eye, for example into a three-dimensional position wherein the optical center of the user's eye is to be positioned, for example as constrained by the frames comprising the near-eye display.

According to an alternative embodiment, the collimating optics of adjacent pixels of the at least one pixel array are arranged such with respect to the central emitters of the adjacent pixels that the collimated light of the adjacent pixels is emitted at essentially the same angle, particularly along or parallel to an optical axis of the collimating optics, particularly wherein the optical assembly comprising the collimating optics, is configured to deflect the emitted and collimated light of the at least one pixel array such that it propagates toward the common center portion of the near-eye display.

According to this embodiment the optical assembly essentially comprises two components; a collimating component comprising the collimating optics and a deflection component that is configured to deflect the collimated light from the collimating optics to the common center portion. This deflection component can for example comprise a plurality of prisms, particularly prism-array that is arranged between the collimating component and the user's yes. The prisms are arranged such that the collimated light is refracted to the common center portion of the near-eye display.

The collimated light from the collimating optics propagates at the same angle or no angle at all with respect to the optical axes of the collimating optics.

This embodiment allows for a sequential assembly of the near-eye display. Furthermore, it allows for a simpler manufacturing process of the pixel array, as each central emitter and each associated collimating element can be arranged identical with respect to each other. Furthermore, in order to arrive at steeper emission angles for the near-eye display this embodiment omits aperture effects from the collimating optics that might occur in pixels for which the emission angle of light becomes too large.

According to another embodiment of the invention, the optical assembly comprises at least one optical element configured to deflect the angle of the collimated emitted light of each pixel array such that the emitted light of the at least one pixel array propagates toward the common center portion of the near-eye display.

The at least one optical element is particularly a separate component from the collimating optics, such as the deflection component. This embodiment allows for a combination of a micro-lens array or a micro-mirror array with the deflection component.

According to a further embodiment of the invention, the at least one optical element is arranged on the at least one pixel array between the collimation optics and the common center portion.

Thus, the emitted light propagates from the collimating optics, such as lenses or mirrors, to the optical element for deflection, and then further to the user's eye at the common center portion.

According to a further development of the invention, the at least one optical element is a refractive element, such as a lens, particularly a field flattening lens or a Fresnel lens or a prism.

In case the optical element is a lens, the focusing effect of the lens can usually be neglected as the beam diameter of the collimated light form the pixel is so small compared to the aperture of the lens that the collimated beam essentially corresponds to a no significant focussing or defocussing of the collimated beam takes place at the lens, such that the collimated light remains essentially unaltered by the lens in terms of its collimation properties. The lens however deflects the collimated light beams toward the common center portion.

A Fresnel lens is for example a suitable refractive element. Alternatively a filed flattening lens can be used as a refractive element.

Thus, according to this embodiment the particularly single lens can extend over the whole pixel array and the collimating optics, rendering an assembly of the near-eye display comparable facile.

According to another embodiment of the invention, the near-eye display comprises a plurality of planar pixel arrays arranged such that the emitted light from the pixel arrays propagates toward the common center portion, particularly wherein the pixel arrays are oriented such with a plane within which the central emitters are arranged that the surface normal to said plane points toward the common center portion.

This embodiment reduces the optical performance requirements of the near-eye display for large angles with respect to the aperture of the common center portion. That is, light incident from the periphery of the field of view of the eye has to propagate at comparable large angles in case the near-eye display comprises only one planar pixel array that is particularly arranged in plane orthogonally to the optical axis of the eye of the user, when the user looks straight forward.

According to this embodiment the plurality of pixel arrays are particularly not arranged in a single plane but in a variety of planes, wherein each pixel array is oriented such with its central emitter plane that the surface normal of said emitter plane is oriented towards the common center portion.

Each pixel array can have a square or rectangular shape. Some pixel arrays of the plurality of pixel arrays might be smaller than other pixel arrays. Each pixel array can have an optical assembly according to any of the disclosed embodiments. As laid out above, some embodiments might be more suitable for large angle deflections, while others require fewer components to be assembled.

According to another embodiment of the invention, the near-eye display comprises a plurality of optical assemblies, wherein each optical assembly is configured to collimate and deflect the emitted light of the at least one pixel array such that the emitted light of the at least one pixel array propagates toward the common center portion of the near-eye display.

This embodiment allows for a plurality of optical assemblies to be arranged on a single pixel array.

This allows for the design of specific deflection properties for a selected pixel array, wherein for example the optical assemblies arranged on the pixel array differ in terms of the deflection angle provided to the collimated light.

In an alternative embodiment, the each pixel array comprises exactly one optical assembly.

The latter embodiment allows for a use of single optical elements such as a lens.

According to a further development of the invention, each optical assembly is arranged on one of the plurality of planar pixel arrays, wherein each optical assembly is configured to collimate and deflect the emitted light of the corresponding pixel array such that the emitted light of the corresponding pixel array propagates toward the common center portion of the near-eye display.

This embodiment essentially allows for a plurality of pixel arrays, wherein each pixel array comprises its own optical assembly. This allows for a piece-wise manufacturing of the near-eye display particularly wherein each pixel array has the same optical properties as each pixel array particularly comprises the same optical assembly.

According to another embodiment of the invention, the plurality of pixel arrays is arranged in the same plane.

This embodiment allows for assembly of smaller pixel arrays next to each other. The pixel arrays might have optical assemblies that are comprised in different embodiments of the invention, which allows selecting suitable optical assemblies for example regarding the desired deflection angle.

According to another embodiment of the invention, the pixel arrays are arranged in different planes, particularly wherein said planes extend tangentially along a curved, particularly spherical or cylindrical manifold.

According to another embodiment of the invention, each pixel array of the plurality of pixel arrays is oriented along the same direction, particularly wherein the at least one optical assembly particularly the plurality of optical assemblies is/are configured to collimate and deflect the light emitted by the pixel arrays such that the emitted light of the pixel arrays propagates toward the common center portion of the near-eye display.

The orientation of the pixel array is particularly defined by the surface normal of the planar pixel array that indicates the orientation of the pixel array. According to this embodiment the orientations of the pixel arrays are therefore parallel to each other. According to this embodiment the orientation of the pixel arrays is particularly parallel to an optical axis of the user's eye when the user looks straight forward.

According to another embodiment of the invention, the pixel arrays are oriented along different directions, particularly wherein the optical assemblies are configured to collimate and deflect the light emitted by the pixel arrays such that the emitted light of the pixel arrays propagates toward the common center portion of the near-eye display.

According to this embodiment the orientations of the pixel arrays as defined in the previous embodiment point in different directions, particularly wherein each pixel array is oriented towards the common center portion.

This allows for use of an optical assembly that provides only deflection of the collimated light such that the light from each of the pixels of each pixel array propagates toward the common center portion. In other words, the optical assembly does no need to provide a “global” deflection angle for each pixel array, but only the deflections of the pixels have to be managed. This embodiment allows for greater optical quality, as larger deflection angles are omitted.

According to another embodiment of the invention, the pixel arrays are spaced apart from each other forming optically transparent or semi-transparent gaps between the pixel arrays.

This embodiment allows for a generally semi-transparent near-eye display allowing the user to see through the near-eye display.

For this purpose the pixel arrays might be arranged on a transparent or semi-transparent carrier, such as glass, or polymer.

According to a different embodiment of the invention, the pixel arrays are arranged gap-less around the common center portion, so as to form a continuous, particularly non-transparent display.

According to another embodiment of the invention, the near-eye display comprises a single pixel array only and particularly wherein the near-eye display further comprises only one optical assembly.

This embodiment allows for a cost-efficient near-eye-display.

According to another embodiment of the invention, the at least one pixel array is arranged on a transparent or semi-transparent substrate, such as galls or a polymer.

This allows augmented reality applications for which a transparent portion of the display is necessary.

According to another embodiment of the invention, each pixel of the at least one pixel array further comprises side-emitters configured to emit light in a controllable fashion, wherein the side-emitters are arranged around the central emitter and wherein emitted light of the side-emitters propagates at an angle with respect to collimated light of the corresponding central emitter of the pixel, particularly with an angle to the optical axis of the collimating optics.

The side emitters are particularly arranged in the same plane as the corresponding central emitter; said plane extending particularly orthogonal to the optical axis of the corresponding pixel.

The central emitter and/or each side-emitter of each optical element can comprise an OLED, a QLED, a quantum dot, or an LED or any other electrically controllable light emitting element.

According to another embodiment of the invention, the central emitter comprises a plurality of quantum dots.

According to another embodiment of the invention, each pixel comprises a reflective portion on which the side emitters are arranged. The reflective portion can be identical to the reflective portion of the central emitter or a different one.

According to another embodiment of the invention, each side emitter is coated with a conductive polymer shell, and is arranged on the reflective portion, wherein the shell provides a fixed distance between a core of the side emitters and the reflective portion, such that each coated side emitter forms an electrochromic nanoparticle-on-mirror (eNPoM) with the reflective portion, such that an emission wavelength of the side emitter is adjustable by adjusting a plasmonic resonance of the eNPOM.

The reflective portion is for example made of a metallic compound, such as gold. The side emitter in the eNPoM is for example made of gold, particularly the core of the side emitter is made of a metal such as gold.

According to another embodiment of the invention, the side emitter is coated with a thin film of a conductive polymer shell, such as polyaniline.

The thin film might have thickness between 1 nm to 50 nm, particularly between 10 nm to 30 nm, more particularly 20 nm.

The core of the side emitter might have diameter in the range of 20 nm to 200 nm, particularly in the range of 50 nm to 150 nm, more particularly in the range of 70 to 90 nm.

Side emitters allow for a better optical impression of the near-eye display. Light emitted from the side-emitters while roughly propagating towards the direction the common center portion, it might also be blocked from an aperture of the common center portion or arrives at a boarder portion of the common center portion.

The side emitters provide a natural perception of the displayed content of the near-eye display, due to its slight angular deviations from the light emitted by the central emitter.

According to another embodiment of the invention, the side-emitters are arranged in an identical pattern around the central emitter for each pixel, particularly such that the emitted light of the side-emitters propagates at predefined angles with respect to the collimated light emitted by the central emitter, particularly with respect to the optical axis of the corresponding collimating optics, when the light leaves the corresponding pixel.

According to another embodiment of the invention, a pattern in which the side-emitters are arranged with respect to the central emitter and particularly with respect to the optical axis of the corresponding collimating optics is different for adjacent pixels of the pixel array.

According to another embodiment of the invention, the distances of the side-emitters to the optical axis of the corresponding collimating optics of the pixel are different for adjacent pixels in the at least one pixel array.

This way different emission angles are generated for each side emitter form different pixels, leading a more natural viewing perception.

According to another embodiment of the invention, each pixel comprises a transparent polymer or glass.

According to another embodiment of the invention, the collimating optics of each pixel comprises a, particularly semi-transparent, concave mirror, particularly wherein the concave mirror comprises a reflective, particularly semi-transparent layer.

The mirrors are arranged between the central emitters and the user's eye. The near-eye display therefore is based on a reflective mode operation.

This embodiment provides a color-aberration-free collimating optics, as the collimating optics are purely reflective and thus wavelength independent.

Semi-transparent mirrors allow for augmented reality applications of the near-eye display.

According to another embodiment of the invention, each concave mirror of the collimating optics is embedded in the transparent polymer or glass.

This reduces any refractive index changes in the pixels, which reduces potential aberrations.

According to another embodiment of the invention, each concave mirror comprises a reflective layer that is a dielectric layer or a metal-comprising layer, particularly an aluminium layer.

According to another embodiment of the invention, the collimating optics of each pixel comprises a collimating lens that is particularly integrally formed by a polymer or a glass of the pixel.

This embodiment provides an integrally formed pixel array providing collimated light, without the need to elaborately position for example a micro-lens array in the pixels.

According to another embodiment of the invention, the central emitter of each pixel is an OLED, a QLED, a quantum dot, an LED, or an intensity- and/or color-controllable light emitter, such as an eNPoM.

Similarly, each side-emitter of each pixel can be an OLED, a QLED, a quantum dot, an LED, or an intensity- and/or color-controllable light emitter, such as an eNPoM.

According to another embodiment of the invention, each pixel comprises more than 3, particularly 4, 8, 15 or 24 side-emitters and particularly only one central emitter, particularly wherein the side-emitters are arranged around the central emitter.

According to another embodiment of the invention, the pitch of the pixels of the at least one pixel array is between 5 μm and 50 μm.

The problem according to the invention is further solved by glasses having a near-eye-display according to the invention.

According to another aspect of the invention, glasses with a first and second window that are each associated to an eye of a person are claimed, wherein the first window comprises a first near-eye display according to the invention.

Such glasses can be used in augmented or virtual reality applications.

The term glasses” in the context of the specification particularly refer to a head-wearable device, that comprises a first portion that is arranged in front of a first eye of the user and a second portion arranged in front of a second eye of a user.

Said first and second portion of the glasses typically yield the eyes either form external influences such as light or dust, and can also be manufactured to have an optical power.

In the context of the specification the first portion comprises the first window and the second portion comprise the second window.

The glasses comprise some means or assembly to hold the glasses on the head of the user, such as for example temples, temple tips, a nose bridge, nose pads.

Additional components can be comprised by the glasses, particularly control elements for the near-eye display as well as an energy source for the near-eye display.

According to another embodiment of the invention, the second window comprises a second near-eye display according to the invention.

This embodiment allows a more immersive augmented reality experience for a user wearing the glasses.

According to another embodiment of the invention, the glasses comprise a first adjustment assembly configured to adjust a distance between the eye of the person wearing the glasses and the first and second window, such that the common centre portion of the first and particularly the second near-eye display can be shifted along an optical axis of the pupil of the eye of the person wearing the glasses.

This embodiment particularly allows for placing the glasses such on the head that a suitable viewing distance to the near eye display(s) can be adjusted by the first adjustment assembly.

Particularly, the first adjustment assembly allows for an adjustment of the visible field of view of the user, and for an adjustment of an acceptance angle.

The adjustment assembly can be facilitated by means of adjustable temples or by a device configured to move the first or the second window along the viewing direction of the user.

According to another embodiment of the invention, the glasses comprise a second adjustment assembly configured to adjust a lateral distance between first and second window, such that the common centre portion of the first and particularly the second near-eye display can be aligned to a distance between a centre of the eyes, particularly a centre of the pupils of the person wearing the glasses.

This second adjustment assembly is for arranging the first and second window such from each other that the at least one near-eye display comprised by the glasses is arranged on the optical axis of the eye(s) of the user when the user looks straight forward.

According to another embodiment of the invention, the glasses comprise a third adjustment assembly configured to adjust a vertical position of the first and second window, with respect to the eyes of a person wearing the glasses, such that the common centre portion of the first and particularly the second near-eye display can be aligned to a centre of the eyes, particularly a centre of the pupils of the person wearing the glasses.

This embodiment allows for arranging the at least one near-eye display vertically such that the optical axes of the eyes match are aligned to the near-field display vertically.

According to another embodiment of the invention, the glasses comprise at least one camera arranged and configured to record a field of view of the person wearing the glasses, wherein the at least one camera is oriented along parallel to an optical axis of the glasses.

This embodiment allows for recording the scene in front of the user of the glasses and particularly for displaying the recorded scene to the user. This embodiment is particularly useful, when the glasses are configured as virtual reality googles that is the glasses are predominantly non-transparent. In order to provide the user with a sense of its surrounding such a feature is important to glasses.

According to another embodiment of the invention, the first and the second window of the glasses are semi-transparent such that a light intensity hitting the eyes of the person wearing the glasses is reduced.

This provides glasses that allow the near-eye displays to be perceived even in bright daylight conditions.

### EXEMPLARY EMBODIMENTS

Particularly, exemplary embodiments are described below in conjunction with the Figures. The Figures are appended to the claims and are accompanied by text explaining individual features of the shown embodiments and aspects of the present invention. Each individual feature shown in the Figures and/or mentioned in said text of the Figures may be incorporated (also in an isolated fashion) into a claim relating to the device according to the present invention.

In general, the near-eye display 1 can be used in augmented, mixed and virtual reality applications. For each use specific embodiments might prove more suitable than others.

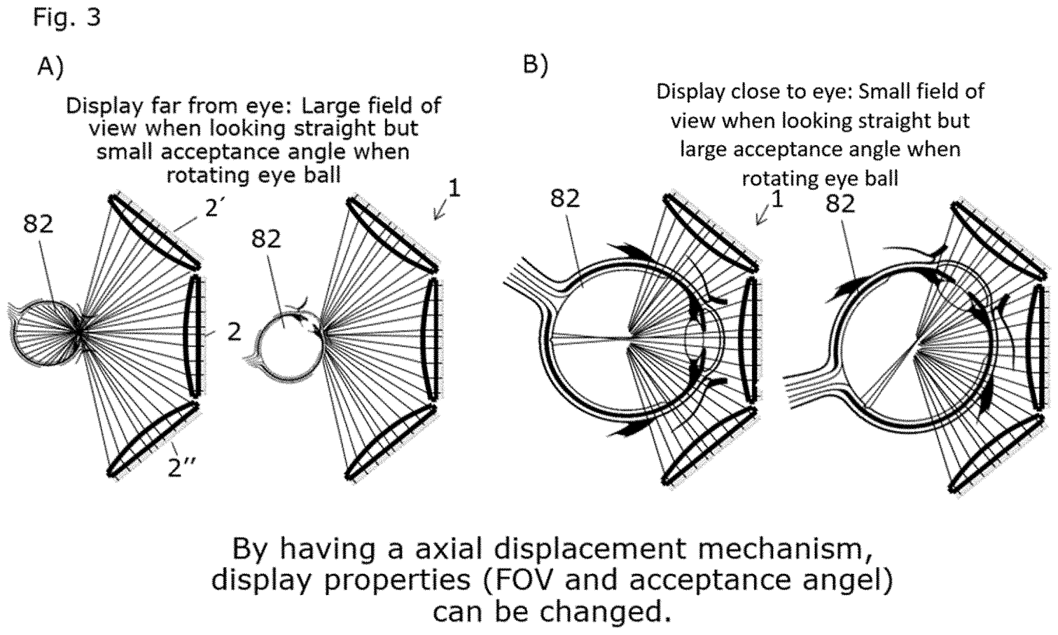

The near-eye display 1 is particularly configured based on the following parameters. Each eye of a human can usually rotate 40 degrees in the horizontal plane (x-direction) in each direction (right and left) and 30 degrees in each direction for the vertical plane (y-direction, up and down). Thus, the near eye display 1 is particularly configured to cover the horizontal angular range as well as the vertical angular range. This is for example achieved by adjusting the distance d to the eyes 82 of the user. The closer the near-eye display 1 is arranged to the eyes, the smaller the near-eye display 1 can be. On the other hand, the closer the near-eye display is arranged to the eyes 82, the smaller the perceptible field of view becomes (cf. FIG. 3). A trade-off between these two properties might be found when the specific requirements and application of the near-eye display 1 are specified.

Moreover, any glasses comprising at least one near-eye-display are based on an average pupil diameter of a human eye under office light is around 3 mm, particularly between 2 mm and 8 mm, which equals the average aperture of the eye. This aperture defines the aperture of the common center portion.

The average distance between eyes is known to be around 65 mm for men and 62 mm for women. Any glasses according to the invention are therefore designed accordingly.

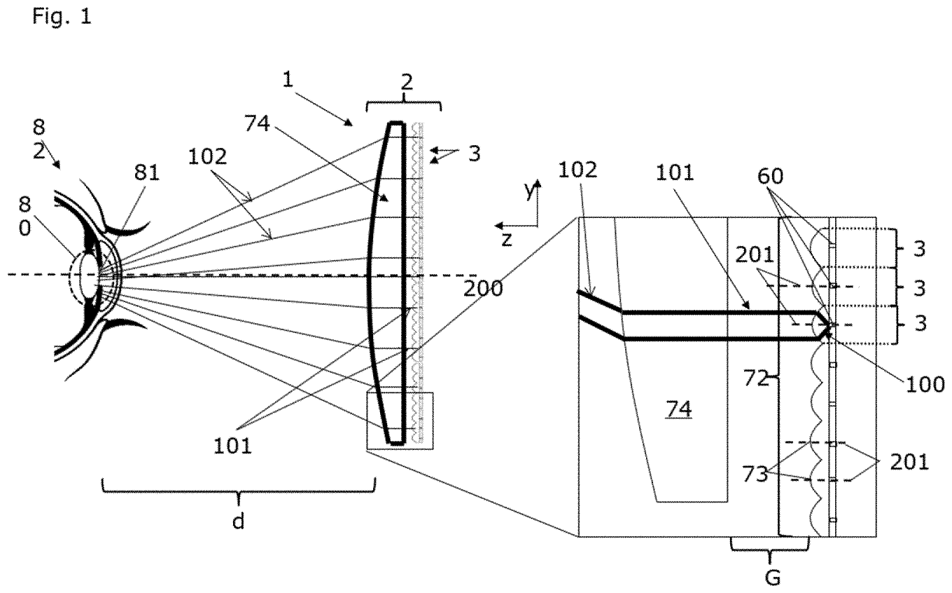

In FIG. 1 a schematic cross-section through a near-eye display 1 is shown. The near-eye display 1 is arranged in front of an eye 82 of the user so close that the user cannot focus on the near-eye display 1 itself.

The near-eye display 1 according to the embodiment shown in FIG. 1 comprises a planar pixel array 2 that is arranged in a plane orthogonal (with the associated Cartesian directions x and y) to the optical axis 200 (associated to the Cartesian axis z) of the eye 82, as the eye looks straight forward.

The pixel array 2 comprises a plurality of pixels 3 that are arranged in regular rows and columns over the entire pixel array 2. Each pixel 3 comprises a central emitter 60 (and in some embodiment also side-emitters cf. FIG. 8) that is arranged in the pixel 3 and that can be controlled in terms of its luminous state. That is the central emitter 60 can be switched on or off. In the off-state the central emitter 60 does not emit light, wherein in the on-state the central emitter 60 emits visible light. The emitted light 100 is highly divergent as the central emitter 60 can be assumed to be a point like emitter. Each central emitter 60 and thus each pixel 3 of the near-eye display 1 can be individually controlled in terms of its light emission.

The central emitters 60 according to the illustrated embodiment are arranged in a regular pattern at identical distances to each other. The central emitters 60 might be incorporated in matrix that allows emission of light only on one side of the near eye display 1. On the side that faces towards the eye of the user (display side), a micro-lens array 72 is arranged such with respect to the central emitters 60 that the optical axis 201 of each lens 73 of the micro-lens array 72 extends through the central emitter 60, and wherein the central emitter 60 is located at the focal point or plane of the respective lens 73.

This causes each pixel 3 to emit light along the optical axis 201 of the corresponding lens 73 of the micro-lens array 72, and that the light 101 exiting the pixels is collimated.

The micro-lens array 72 according to this embodiment has the same pitch for the lenses 73 as the central emitters 60.

The pixel array 2 can comprise a reflective layer on the backside that is the side facing away from the eye of the user (cf. FIG. 8).

In order to deflect the collimated light 101 from each pixel 3 of the pixel array 2 towards the common center portion 80 the near-eye display 1 comprises a deflection component 74. The deflection component 74 in the illustrated embodiment is a field flattening lens 74 that is arranged on the micro-lens array 72.

As the aperture of the field flattening lens 74 is considerably larger than a single collimated light beam 101 from a single pixel 3, the field flattening lens 74 particularly acts like a prism on each light beam 101, meaning that the collimation properties of each beam 101 are essentially unaltered, when the light passes through the field flattening lens 74. However, the deflection of the light emitted by the pixels 3 is locally varying such that the light is deflected 102—in this case refracted—towards the common center portion 80 of the near eye display 1.

According to one notion, the common center portion 80 can be considered as the focal point (or portion) of the field flattening lens 74 or more general the optical assembly 70.

The field flattening lens 74 has particularly the same diameter or a larger diameter than the pixel array 2. The lens 74 can comprise glass or a polymer.

The micro-lens array 72 can comprise a polymer or glass. It is noted that between the field flattening lens 74 and the micro-lens array 72 there is a gap G that has a different refractive index than the microlens array 72 in order to provide a refractive surface to the micro-lens array 72. This gap G can be for example air or gas filled.

The light beams propagating towards the common center portion 80 will eventually hit the eye 82 of the user, particularly the pupil 81.

The pupil 81 acts as an aperture that defines an aperture of the common center portion 80.

The projection of the light entering the pupil 81 onto the retina will then evoke a visual impression on the user of the near-eye display 1.

In the boxed region of FIG. 1 a detail view of the near eye display 1 is shown.

As can be seen the central emitters 60 are equally spaced from each other along the y-direction and also along the x-direction; not shown).

The emitted light 100 from the central emitter 60 is exemplary shown for one emitter as light rays. The emitted light 100 is highly divergent until it is collimated 101 by the lens 73 from the micro-lens array 72 associated to the central emitter 60.

The collimated light 101 propagates along the optical axis 201 of the corresponding associated lens 73 of the micro-lens array 72 and eventually traverses the field flattening lens 74, at which the light is refracted 102 towards the common center portion 80. The degree of deflection or in this case the degree of refraction is particularly determined by the focal power of the field flattening lens 74.

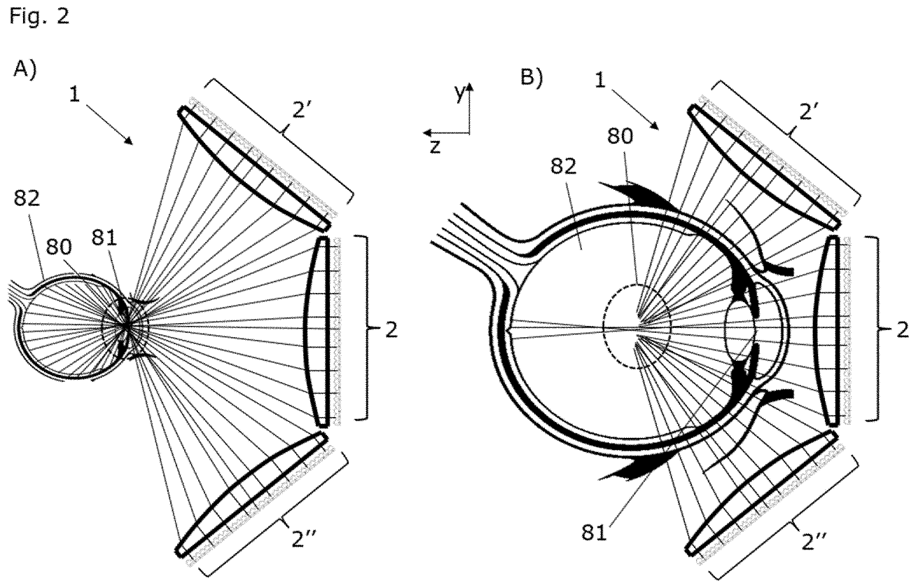

FIG. 2 schematically shows an embodiment of the invention that comprises three planar pixel arrays 2, 2′, 2″ that are arranged around and oriented towards the common center portion 80 of the near-eye display 1. Each pixel array 2, 2′, 2″ is essentially composed identically to the embodiment shown in FIG. 1 and will not be elaborated at this point but reference is made to the description of FIG. 1.

The near eye-display 1 in FIG. 2 comprises three pixel arrays 2, 2′, 2″ that are vertically (along the y-direction) arranged over each other, such that a larger solid angle is covered.

The near-eye display 1 of FIG. 2 can cover a larger acceptance angle than a near-eye display 1 that comprises only one pixel array 2.

The acceptance angle is the angle that the eye 82 of the user can still assume without covering portions from which no light is emitted from the near-eye display 1, i.e. without the eye 82 looking past the near-eye display 1 sideways.

In panel A of FIG. 2 the near-eye display is arranged further away from the eye of the user than in panel B of FIG. 2. As can be seen the common center portion 80 of the near-eye display 1 is correspondingly shifted. In panel A this leads to a larger field of view for the user when the user looks straight forward, as almost no light is rejected at the pupils 81 aperture. In panel B however, the pupil 81 blocks many light rays from entering the eye 82 such that a smaller field of view can be observed at the same time by the user. On the other hand this allows for the user to rotate the eye 82 due to a larger acceptance angle (cf. FIG. 3).

Therefore, a field of view and the acceptance angle of the near-eye display 1 can be adjusted by adjusting the distance to the eye of the near-eye display.

This situation is shown in greater detail in FIG. 3. In panel A of FIG. 3 the situation as depicted in FIG. 2 panel A is shown, with the eye 82 looking straight (left side of panel A) and with the eye 82 assuming a vertical angle (right side of panel A). In the latter case the eye 82 looks essentially past the near-eye display 1 as the acceptance angle of the near-eye display 1 in the “far” position is too small to cover the whole angular range of the eye 82.

In panel B of FIG. 3 the situation as depicted in FIG. 2 panel B is shown, with the eye 82 looking straight (left side of panel B) and with the eye 82 assuming a vertical angle (right side of panel B). In both cases the field of view is covered by the near-eye display 1 and images can be displayed to the user at all angles. This larger acceptance angle however comes at the cost of a smaller field of view as compared to the situation depicted in panel A of FIG. 3.

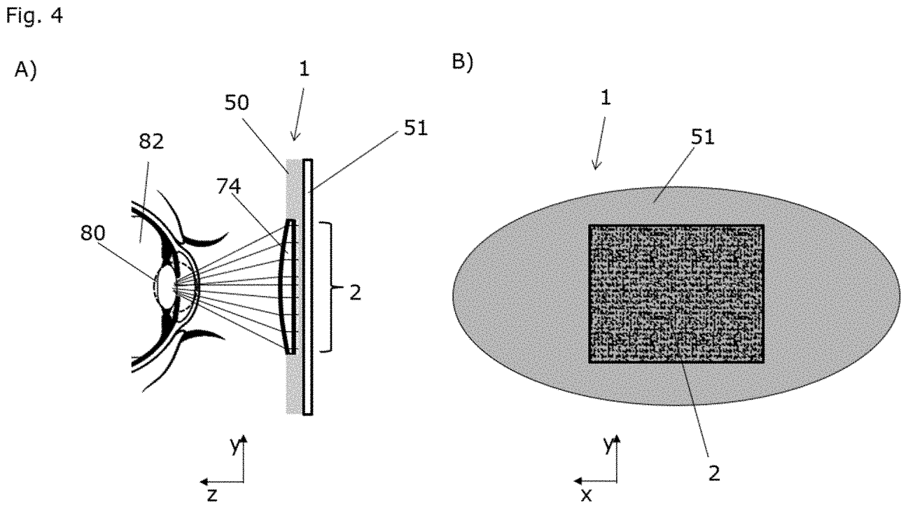

FIG. 4 shows an embodiment of the near-eye display 1, where the near-eye display is comprised and embedded in a transparent substrate such as a polymer. The substrate is arranged on a light filter for reducing the light intensity. This allows the use of the near-eye display 1 in daylight conditions. Moreover, the near-display 1 comprises only a single pixel array 2 as shown already in FIG. 1. This allows the user to look past the pixel array 2 and thus to perceive the surrounding allowing for example augmented reality applications.

In panel A of FIG. 4 the schematic cross-section of the near-eye display 1 is shown and in panel B a frontal view of the near-eye display 1 is shown.

The substrate 50 is arranged on the light filter 51. The light filter 51 can for example be a semi-transparent glass or polymer or a window of glasses.

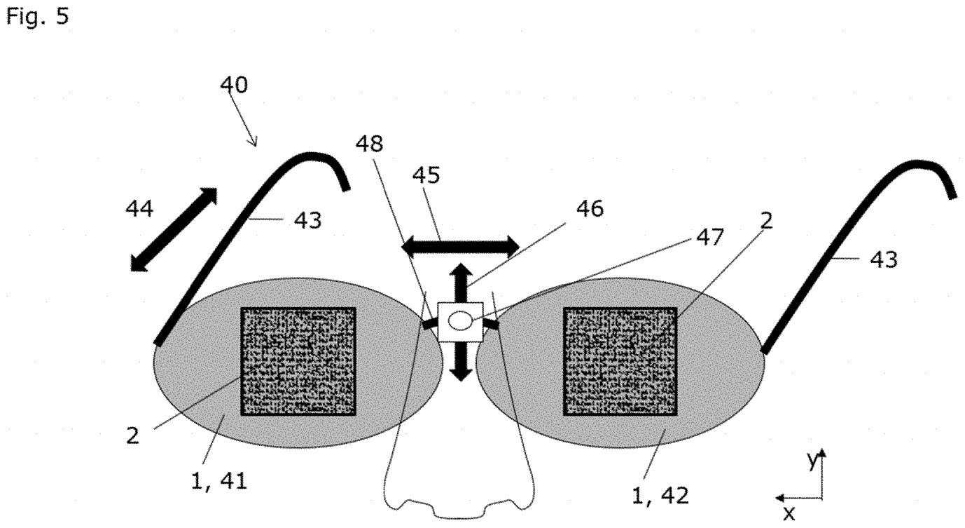

In panel B of FIG. 4 a front view of the near-eye display 1 is shown. Combining two of such embodiments to glasses results in an embodiment as depicted in FIG. 5.

In FIG. 5 glasses 40 according to the invention are schematically illustrated. The glasses 40 comprise a first and a second window 41, 42 for shielding the eye of the user. In analogy to FIG. 4, the windows 41, 42, each comprise a near-eye display 1 embedded in a transparent substrate that is arranged on a light filter (not shown in FIG. 5) as described already in the context of FIG. 4.

The near-eye displays 1 are arranged centrally on the windows 41, 42. The glasses 40 comprise a first adjustment assembly 44 that is configured to move (indicated by the double arrow 44) the first and the second window 41, 42 towards or away from the face of the user, such that a distance between the eyes and the near-eye displays 1 can be adjusted, such that the field of view and the acceptance angle can be adjusted as illustrated in FIGS. 2 and 3.

The first adjustment assembly 44 can be comprised or incorporated both temples 43 of the glasses 40. The first adjustment assembly 44 can be a translational device.

Alternatively, the first adjustment assembly 44 can be incorporated in the glasses 40 such that only the first and the second window 41, 42 can be moved closer or further apart from the face of the user. This allows the nose bridge 48 of the glasses 40 to remain at the same position, which in turn increases wearing comfort.

The latter embodiment would typically involve four translational devices, two for each window 41, 42. For example one translational device could be arranged at the connection of the temples 43 with the glasses 40 and a second translational device would be arranged at the nose bridge 48 (this embodiment is not shown)

The glasses 40 shown in FIG. 5 have the near-eye displays 1 particularly arranged at a lateral distance that corresponds to the average lateral distance of the pupils, e.g. a distance between 62 and 65 mm. This means that the center of each near-eye display 1 should be on the optical axes of the respective eye looking at the near-eye display 1.

As the lateral pupil distance might vary between different users, the glasses 40 have a second adjustment assembly 45 that is configured to adjust the lateral distance between the near eye-displays 1, i.e. the lateral distance between the centers of the near-eye displays 1. This allows centering the near-eye displays 1 of the glasses 40 with respect to the pupils of the user. The lateral adjustment particularly affects a distance along the x-axis of the near-eye-displays 1.

The second adjustment assembly 45 is arranged at the nose bridge 48 and moves (indicated by the double arrow 48) the first and the second window 41, 42 in order to move the near-eye displays 1. Thus, also the second adjustment assembly 45 can be for example a translational device configured to perform translation of the first and/or the second window 41, 42 along the x-axis.

In order to fully adjust the position of the near-eye displays 1 to the pupils position also a vertical adjustment (indicated by the double arrow 46) might be necessary. Therefore, the embodiment shown in FIG. 5 also comprises a third adjustment assembly 46 that is configured to move the windows 41, 42 of the glasses 40 particularly individually up and down along the y-axis. This way, the centers of the near-eye displays 1 can be brought in alignment with the optical axes of the pupils of the user.

The third adjustment assembly 46 can be a single translator device arranged on the nose bridge 48 of the glasses 40.

In order to provide the user with the possibility to make the glasses 40 completely transparent also in the portions where the near-eye displays 1 are located, the glasses 40 can comprise a camera 47 that is arranged to record the scene around the user's field of view.

The acquired images can be displayed on the near-eye displays 1, such that the user can see the direct environment in his field of view, rendering the near-eye displays 1 essentially transparent and invisible.

For this purpose, also a stereo camera can be used such that each eye is provided with the correct viewing angle on the scene. The stereo camera can for example be arranged at the centers of the near eye displays 1 on the side facing away from the face of the user. Alternatively, the cameras can be arranged on the upper rim portions of the windows 41, 42.

In the depicted embodiment a single camera 47 is arranged on the nose bridge 48.

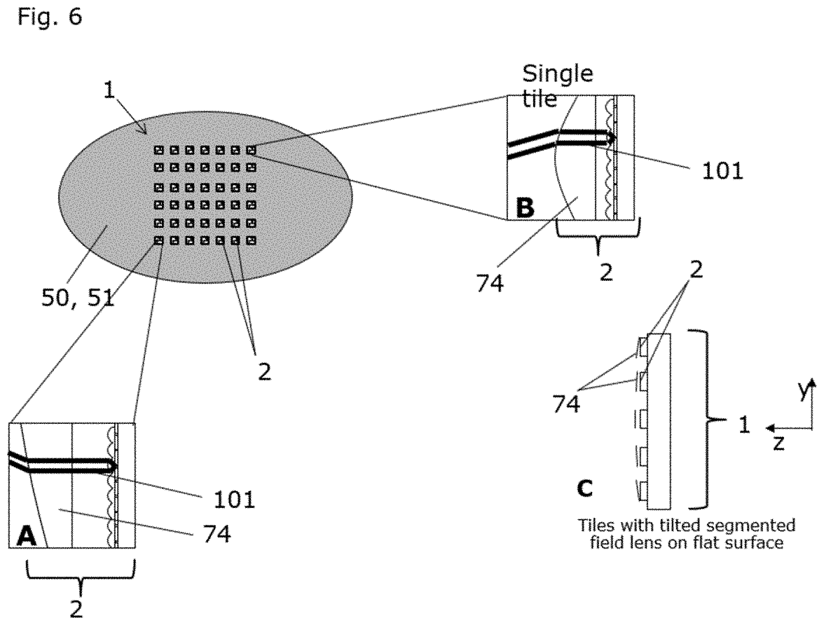

FIG. 6 shows an exemplary embodiment of the near-eye display 1 that can be part of glasses as described previously, wherein the near-eye display 1 comprises a plurality of pixel arrays 2 that are all oriented in the same direction, namely towards a common z-axis. The pixel arrays 2 are arranged on an even and planar window 51 or in a planar substrate 50. The window 51 or substrate 50 is at least semi-transparent, such that in portions where no pixel array 2 is arranged the user can see its direct environment. The pixel arrays 2 are furthermore arranged in a regular pattern, wherein between the pixel arrays 2 there is a transparent lateral gap.

Each pixel array 2 comprises plurality of pixels, wherein each pixel array 2 comprises an optical assembly, for example in form of a prism or a field flattening lens 74. The general layouts and composition of a single pixel array 2 has been elaborated previously and can be applied in the same fashion to this embodiment.

The gaps between the pixel arrays 2 are free of additional optical components except the window 51, an optional light filter or an optional substrate.

The plurality of pixel arrays 2 with its optical assemblies forms the near-eye display 1.

In the magnified portions A and B two pixel arrays 2 are shown in more detail in a cross-section.

In both portions A and B the pixels with the collimating optics and the field flattening lens 74 or prism for deflecting the collimated light from the pixels towards the common center portion can be seen.

Each pixel array 2 depending on its position in the near-eye display 1 has a different field flattening lens 74 or prism in order to provide the correct deflection angle toward the common center portion. This is schematically depicted when comparing the cross-sections of portion A and B, where different field flattening lenses 74 or prisms can be seen.

A cross section along the y-axis of the near-eye display is shown in panel C of FIG. 6.

Here, in an exemplary fashion five pixel arrays 2 are arranged on the window, all having the same orientation. The pixel arrays 2 on the very top and bottom comprise a filed flattening lens 74 or prism providing a strong deflection of the collimated light towards the optical axis of the users eye (shown as a dotted line), wherein the pixels comprised in the pixel arrays 2 in the middle essentially require less deflection by the optical assembly/optical element of the pixel array 2.

The near-eye display 1 depicted in FIG. 6 can essentially be understood as a near-eye display 1 with a single pixel array 2 and a single optical assembly 74, wherein the near-eye display 1 has cut-out portions where portions of the single pixel array and the optical assembly has been cut away leaving transparent lateral gaps.

This embodiment allows the use of non-transparent pixel arrays 2 based on silicon technology while allowing for augmented reality (partial see through).

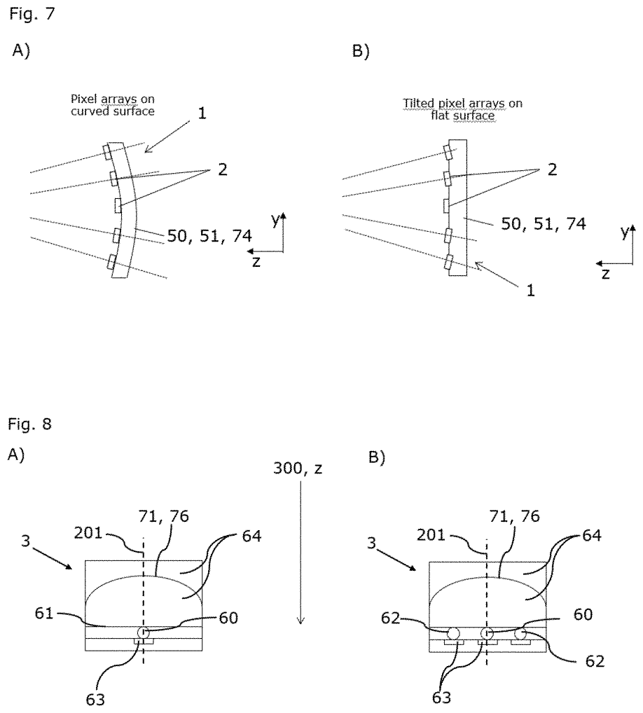

In FIG. 7 an alternative layout for a near-eye display 1 with a plurality of pixel arrays 2 is schematically shown in cross-sections. While the general architecture remains essentially the same (lateral gaps between the pixel arrays 2, pixel arrays being arranged on a window of the glasses), the notable difference between the embodiment shown in FIG. 6 is that in panel A an embodiment is shown, where each pixel array is essentially are planar (in reference to the plane within which the central emitters 60 arranged), but arranged in a curved substrate or window, wherein the curvature is such that the emitted light (depicted as dotted lines) from the pixel arrays 2 generally propagates towards the common center portion of the near-eye display. The optical assembly 74 corresponds in this case to the curved window or substrate. Alternatively or additionally, each pixel array 2 has its own optical element (not shown) arranged on the pixel array 2 in order to deflect the collimated light of each pixel individually towards the common center portion.

An alternative embodiment is shown in FIG. 7 panel B, where the pixel arrays 2 are arranged on a planar window 50 or substrate 51, but with orientations (depicted as dotted lines) that correspond to an arrangement on a curved substrate. That is the pixel arrays 2 are generally oriented towards the common center portion. Here, the optical assembly 74 corresponds to the arrangement of the pixel arrays 2 in a tilted fashion on the planar window 50 or substrate 51. Alternatively or additionally, each pixel array 2 has its own optical element (not shown) arranged on the pixel array 2 in order to deflect the collimated light of each pixel individually towards the common center portion.

The embodiments shown in FIGS. 6 and 7 can be used in glasses 40 according to the invention.

In FIG. 8 the side of the pixel to which light is emitted is indicated by the arrow 300.

In FIG. 8 panel A, a single pixel 3 of the pixel array is schematically shown in a cross-section.

The pixel 3 comprises a transparent polymer 64, in which the semi-transparent or non-transparent concave mirror 76 is embedded as the collimating optics 71 for the pixel 3.

As the central emitter 60 is arranged at the focal point of the collimating optics 71, light emitted from the central emitter 60 is collimated by the collimating optics 71.

The central emitter 60 is contacted by electrodes that consist of a transparent compound such as ITO. Via the electrodes 61 the central emitter 60 can be switched between the on- and off-state, e.g. by applying an electric field or by supplying an electric current or voltage to the central emitter 60. The central and/or side-emitter(s) 60, 62 (cf. panel B) are arranged on a reflective or an absorbing portion 63 that prevents emission of divergent light of the central and/or side-emitters 60, 62 directly towards the display side—the side where the eyes are, of the near-eye display 1. Alternatively, the absorbing or reflective portion 61 can be comprised by the central/side emitters 60, 62.

The pixel 3 is optically transparent to the eye 82 and has two planar surfaces that do not alter the wavefronts of light traversing the pixel 3 from the backside to the display side of the pixel array 2. The only focusing element of the pixel 3 is the concave mirror 76.

The collimating optics 71 can be formed with a parabolic, spherical or aspheric, reflective layer.

Whether the layer is semi-transparent or fully reflective depends on the intended use of the near-eye display 1—for virtual reality applications a fully reflective layer can be chosen, wherein for augmented reality and mixed reality applications, the layer can be chosen semi-transparent.

The configuration with the reflective portion may also be used to create a nanoparticle-on-mirror device, eNPOM, by arranging the central and/or side emitter at a fixed distance to the reflective portion and coat the emitter with an appropriate layer, such that plasmonic emission may be achieved. This is further elaborated in some previous embodiments and can be also interpreted to the schematic pixel depicted in FIG. 8.

In FIG. 8 panel B, a single pixel 3 of the pixel array 2 is schematically shown in a cross-section. In contrast to the pixel 3 in panel A of FIG. 8, the pixel 3 has two side-emitters 62 arranged laterally shifted to the optical axis 201 of the collimating optics 71. The optical axis 201 of the collimating optics 71 is at the same time also the optical axis 201 of the pixel 3.

The pixel 3 comprises eight such side-emitters 62 that are arranged around the central emitter 60. However, in the depicted cross-section only two side-emitters 62 can be seen, as the other side-emitters are arranged in different cross-sectional planes of the pixel 3.

Light emitted by the side-emitters 62 will most likely be less collimated and particularly slightly divergent as compared to the light of the central emitter 60, after passing the collimating optics 71, except when placed at the focal plane of the corresponding collimating optics 71. The focal plane might not be planar, though. Furthermore, after passing the collimation optics 71, the light of the side-emitters 62 propagates at an angle with respect to the optical axis 201 of the pixel 3. Therefore, the light of the side-emitter 62 will hit the retina of the eye 82 at a different location than the light of the central emitter 60.

In the following, the light from the side-emitters 62 is referred to as background light. The background light particularly leads to a more natural viewing impression to the user. The natural viewing experience is caused by the side-emitters by illuminating the part of the retina that is not covered by the fovea but still perceives light.

The side-emitters 62 and the central emitter 60 each are controllable in their luminous states, i.e. they can be switched between the on-state and the off state independently of each other and repeatedly.

The side-emitters 62 are essentially the same kind of emitters than the central emitter 60. Consequently, electric contacting and layout of the side-emitters 62 are essentially identical, e.g. using electrodes.

It is noted that perception of a sharp image is already completely achieved by the use of the central emitters 60. The side-emitters 62 are not mandatory in order to project a sharp image on the retina of the user. The image composed only by central emitters 60 passing through the pupil however would induce a tunnel-like viewing experience if the background light from the side-emitters 62 is turned off.

### REFERENCES NUMBERS

1 near-eye display
2, 2′, 2″ pixel array
3 pixel
40 glasses
41 first window
42 second window
43 temples
44 first adjustment assembly
45 second adjustment assembly
46 third adjustment assembly
47 camera
48 nose bridge
50 substrate
51 light filter/window
60 central emitter
61 contacting electrode
62 side emitters
63 reflecting/absorbing portion
64 transparent polymer
70 optical assembly
71 collimating optics
72 micro-lens array
73 collimating lens of a pixel
74 field flattening lens
76 concave mirror
80 common center portion
81 pupil
82 eye
100 divergent light
101 collimated light
102 deflected collimated light
200 optical axis of the eye
201 optical axis of the collimating optics
300 direction towards the face/emission side
d distance to eye

I claim:

1. A near-eye display (1) comprising at least one pixel array (2), wherein the at least one pixel array (2) is planar and comprises a plurality of pixels (3) arranged in a plane, wherein each pixel (3) comprises a central emitter (60) configured to emit light in a controllable fashion, wherein the at least one pixel array (2) comprises an optical assembly (70) configured and adapted to collimate emitted light from each central emitter (60) of the pixel array (2) and to deflect the collimated light (101) from each pixel (3) such that the light emitted (100) from the central emitter (60) of each pixel (3) of the pixel array (2) propagates toward a common center portion (80) of the near-eye display (1).

2. The near-eye display (1) according to claim 1, wherein the optical assembly (70) comprises a collimating optics (71) comprised by each pixel (3), particularly wherein the collimating optics (71) is a micro-lens array (72) or a micro-mirror array, wherein the collimating optics (71) of each pixel (3) is arranged such with respect to the central emitter (60) that emitted light from the central emitter (60) is essentially collimated by the collimating optics (71).

3. The near-eye display (1) according to claim 2, wherein the collimating optics (71) of adjacent pixels (3) are arranged such with respect to the central emitters (60) of the adjacent pixels (3) that the collimated light (101) of the adjacent pixels (3) is emitted at different angles, such that the emitted light of the at least one pixel array (2) propagates toward the common center portion (80) of the near-eye display (1), particularly wherein the optical assembly (70) is formed by the collimating optics (71) only.

4. The near-eye display (1) according to claim 2, wherein the collimating optics (71) of adjacent pixels (3) are arranged such with respect to the central emitters (60) of the adjacent pixels (3) that the collimated light (101) of the adjacent pixels (3) is emitted at the same angle, particularly along or parallel to an optical axis (201) of the collimating optics (71).

5. The near-eye display (1) according to claim 1, wherein the optical assembly (70) comprises at least one optical element (74) configured to deflect the collimated emitted light of each pixel array (2) such that the emitted light of the at least one pixel array (2) propagates toward the common center portion (80) of the near-eye display (1).

6. The near-eye display (1) according to claim 5, wherein the at least one optical element is arranged on the at least one pixel array (2) between the collimation optics and the common center portion.

7. The near-eye display (1) according to claim 5, wherein the at least one optical element is a refractive element, such as a lens, particularly a field flattening lens (74) or a Fresnel lens or a prism.

8. The near-eye display (1) according to claim 1, wherein the near-eye display (1) comprises a plurality of planar pixel arrays (2) arranged such that the emitted light from the pixel arrays (2) propagates toward the common center portion (80).

9. The near-eye display (1) according to claim 1, wherein the near-eye display (1) comprises a plurality of optical assemblies (70), wherein each optical assembly (70) is configured to collimate and deflect the emitted light of the at least one pixel array (2) such that the emitted light of the at least one pixel array (2) propagates toward the common center portion (80) of the near-eye display (1).

10. The near-eye display (1) according to claim 8, wherein each optical assembly (70) is arranged on one of the plurality of planar pixel arrays (2), wherein each optical assembly (70) is configured to collimate and deflect the emitted light of the corresponding pixel array (2) such that the emitted light of the corresponding pixel array (2) propagates toward the common center portion (80) of the near-eye display (1).

11. The near-eye display (1) according to claim 8, wherein each pixel array (2) of the plurality of pixel arrays (2) is oriented along the same direction, particularly wherein the at least one particularly the plurality of optical assemblies is/are configured to collimate and deflect the light emitted by the pixel arrays such that the emitted light of the pixel arrays (2) propagates toward the common center portion of the near-eye display (1).

12. The near-eyes display (1) according to claim 8, wherein the pixel arrays (2) are oriented along different directions, particularly wherein the optical assemblies (70) are configured to collimate and deflect the light emitted by the pixel arrays (2) such that the emitted light of the pixel arrays (2) propagates toward the common center portion (80) of the near-eye display (1).

13. The near-eye display (1) according to claim 8, wherein the pixel arrays (2) are spaced apart from each other forming optically transparent or semi-transparent gaps between the pixel arrays.

14. The near-eye display (1) according to claim 1, wherein the near-eye display (1) comprises one pixel array (2) only and particularly wherein the near-eye display (1) further comprises only one optical assembly (70).

15. The near-eye display (1) according to claim 2, wherein the collimating optics (71) of each pixel (3) comprises a collimating lens (73) that is particularly formed by a polymer or glass of the pixel (3).

16. The near-eye display (1) according to claim 1, wherein each pixel comprises a reflective portion on which the central emitter is arranged at a fixed distance, such that the reflective portion (63) and the central emitter form a nanoparticle-on-mirror plasmonic device.

17. Glasses (40) having a first window (41) and second window (42) each associated to an eye (2) of a person, wherein the first window (41) comprises a first near-eye display (1) according to claim 1.

18. The glasses (40) according to claim 17, wherein the second window (42) comprises a second near-eye display (1) comprising at least one pixel array (2), wherein the at least one pixel array (2) is planar and comprises a plurality of pixels (3) arranged in a plane, wherein each pixel (3) comprises a central emitter (60) configured to emit light in a controllable fashion, wherein the at least one pixel array (2) comprises an optical assembly (70) configured and adapted to collimate emitted light from each central emitter (60) of the pixel array (2) and to deflect the collimated light (101) from each pixel (3) such that the light emitted (100) from the central emitter (60) of each pixel (3) of the pixel array (2) propagates toward a common center portion (80) of the near-eye display (1).

19. The glasses (40) according to claim 17, wherein the glasses (40) comprise a first adjustment assembly (44) configured to adjust a distance between the eye (82) of the person wearing the glasses (40) and the first as well as the second window (41, 42), such that the common centre portion (80) of the first and particularly the second near-eye display (1) can be shifted along an optical axis (200) of the pupil (81) of the eye (82) of the person wearing the glasses (40).

20. The glasses according to claim 17, wherein the glasses (40) comprise a second adjustment assembly (45) configured to adjust a lateral distance between first and the second window (41, 42), such that the common centre portion (80) of the first and particularly the second near-eye display (1) can be aligned to a distance between a centre of the eyes (82), particularly a centre of the pupils (81) of the person wearing the glasses (40).

21. The glasses (40) according to claim 17, wherein the glasses (40) comprise a third adjustment assembly (46) configured to adjust a vertical position of the first and the second window (41, 42), with respect to the eyes (82) of a person wearing the glasses (40), such that the common centre portion (80) of the first and particularly the second near-eye display (1) can be aligned to a centre of the eyes (82), particularly a centre of the pupils (81) of the person wearing the glasses (40).

22. The glasses (40) according to claim 17, wherein the glasses (40) comprise at least one camera (47) arranged and configured to record a field of view of the person wearing the glasses (40), wherein the at least one camera (47) is oriented along parallel to an optical axis (200) of the eyes (82) of the person wearing the glasses (40).

23. The glasses (40) according to claim 17, wherein the windows (41, 42) of the glasses (40) are semi-transparent such that a light intensity hitting the eyes (82) of the person wearing the glasses (40) is reduced.
